(19) United States
(12) Patent Application Publication
(10) Pub. No.: US 2017/0010153 A1
(43) Pub. Date: Jan. 12, 2017

(54) SPECTROSCOPIC MAPPING SYSTEM AND METHOD

(71) Applicant: HORIBA INSTRUMENTS INCORPORATED, Irvine, CA (US)

(72) Inventors: Nicolas VEZARD, Edison, NJ (US); Beth FINAMORE, Rahway, NJ (US); Jeremy GOLDSTONE, Hillsborough, NJ (US); Gregoire VERRIER, Matawan, NJ (US)

(73) Assignee: HORIBA INSTRUMENTS INCORPORATED, Irvine, CA (US)

(21) Appl. No.: 15/115,497

(22) PCT Filed: Jan. 30, 2015
(86) PCT No.: PCT/US2015/013910

§ 371 Date: Jul. 29, 2016

Related U.S. Application Data
(60) Provisional application No. 61/933,726, filed on Jan. 30, 2014.

(51) Int. Cl. G01J 3/02; G01J 3/04; G01J 3/06; G01J 3/28; G01J 3/18

(52) U.S. Cl. CPC G01J 3/0229; G01J 3/2823; G01J 3/0218; G01J 3/0202; G01J 3/18; G01J 3/06; G01J 3/04; G01J 2003/064; G01J 2003/1828

(57) ABSTRACT

A system and method for spectroscopic mapping, with configurable spatial resolution, of an object include a fiber optic bundle having a plurality of optical fibers arranged in a first array at an input end with each of the plurality of optical fibers spaced one from another and arranged in at least one linear array at an output end. A first mask defining a plurality of apertures equal to or greater in number than the plurality of optical fibers is positioned between an object to be imaged and the input end of the fiber optic bundle. An imaging spectrometer is positioned to receive light from the output end of the fiber optic bundle and to generate spectra of the object. A sensor associated with the imaging spectrometer converts the spectra to electrical output signals for processing by an associated computer.

### CROSS-REFERENCE TO RELATED APPLICATIONS

This application claims the benefit of U.S. provisional application Ser. No. 61/933,726 filed Jan. 30, 2014, the disclosure of which is hereby incorporated in its entirety by reference herein.

### TECHNICAL FIELD

This disclosure relates to a system and method for real-time spectroscopic data collection and discrete mapping with configurable spatial resolution.

### BACKGROUND

While various spectroscopic mapping systems have been developed, there appears to be none that cover the UV-VIS-NIR range in a single analysis, starting from 200 nm, and with speeds of 10-25-50 Hz, and resolutions in the range of about 1-5 nm or better. In addition, existing systems do not appear to provide spatial resolution control suitable for various applications. Such a device may be used to monitor spectroscopic uniformity during a manufacturing process or during testing, for combustion monitoring, or for biology applications. Systems are usually limited in spectral range, speed, and spectral resolution while featuring more spatial information than needed. : Hyper Spectral imagers don't offer all of the following capabilities in the same instrument: sensitivity down to 200 nm, resolution down to 1-2 nm, selectable number and size of spots being monitored, and 10 Hz to 50 Hz acquisition speed for tens to hundreds of simultaneous broadband spectra.

Patents on imaging spectrometers (concentric and Dyson) include: French Publication No. 2 653 879 Enregistrement: 89 14075, Oct. 26, 1989, which discloses a concentric design using a convex grating and one or two concave mirrors. Another French Publication number WO2010061090 A1 discloses a Dyson design and a modified concentric concept using a concave grating and one or two convex mirrors. Various patents disclose imaging spectrometers, such as U.S. Pat. No. 5,859,702; U.S. Pat. No. 5,768,040; and U.S. Pat. No. 5,880,834, for example. Other published patent applications disclose fiber optic arrays having adjacent fibers and non-simultaneous readout, such as US 2009/0040519, for example. Existing hyper-spectral imagers do not provide desired sensitivity down to 200 nm, resolution down to 1-2 nm, a selectable number and sizes of spots being monitored, and 10 Hz to 50 Hz acquisition speed for tens to hundreds of simultaneous broadband spectra.

### SUMMARY

A system for spectroscopic mapping according to one or more embodiments of the present disclosure includes a first mask having a plurality of apertures positioned between an object and an optical bundle having a plurality of optical fibers arranged in a two-dimensional array at an input and at least one linear array at an output, a second mask positioned between the output of said optical fiber bundle and an input of an imaging spectrometer positioned to receive light from at least one of said linear array(s) after passing through the second mask and to separate the light into component wavelengths. Imaging optics may be positioned between the object and the input of the fiber optic bundle. The first mask may be positioned between the object and the imaging optics. Alternatively, the first mask may be positioned between the imaging optics and the input of the fiber optic bundle. The spectrometer may include a longpass, bandpass, or shortpass filter, or an order sorting filter (or more than one) to remove any undesired light , and a sensor with associated readout electronics disposed to receive the desired wavelength range and to generate corresponding signals for analysis by a computer to monitor the object. The first mask includes a plurality of apertures each having an area less than or equal to the area of an associated optical fibers located at the input of the optical fiber bundle. The aperture size and position of the plurality of apertures in the first mask are used to control the spatial resolution of the object or its image onto the fiber bundle array. The second mask is sized to control the spectral resolution of the imaged spectra generated on the sensor.

In various embodiments, the first mask may be implemented using apertures of various shapes and sizes to provide a desired spatial resolution depending on the particular application and implementation for the object being monitored. The input end of the fiber optic bundle may have the individual fibers, adjacent to each other or not, arranged at equidistant or irregularly spaced locations that populate a region matching a portion of, or the entire size of, the focal plane of the chromatically corrected imaging optics. The imaging optics may be implemented by a mirror system to provide magnification, demagnification, or a one-to-one imaging ratio. Similarly, a mirror based microscope objective may be used to provide a magnifying system. Alternatively, imaging optics may include far-range optical set ups such as telescopes. Similarly, the imaging optics may include one or more lens-based magnifying or demagnifying optical systems to provide an image of the object on the input of the fiber optic bundle. Selection of a particular type of imaging system depends on the size and type of object being imaged, the wavelength range, and various other application-specific considerations.

Embodiments may include a method for spectroscopically mapping an object using an imaging spectrometer. The method may include, imaging the object on an input end of a fiber optic bundle having a plurality of optical fibers arranged in a two-dimensional array at an input end and at least one linear array at an output end, the output end directing light to an input of the imaging spectrometer. The method may also include positioning a first mask having a plurality of apertures between the object and the input end of the fiber optic bundle, the plurality of apertures being greater than or equal in number to the plurality of optical fibers. In one embodiment, the method includes moving at least one of the following: the first mask or the input end of the fiber optic bundle relative to one another. Embodiments may include imaging the object by positioning imaging optics between the object and the input end of the fiber optic bundle to align an image plane of the imaging optics with the input end of the fiber optic bundle. Positioning a first mask may include positioning the first mask between the object and the imaging optics. The method may also include positioning a second mask between the output end of the fiber optic bundle and the input of the imaging spectrometer. In other embodiments, the method may include positioning a third mask at a Fourier plane of the imaging optics.

One or more embodiments according to the present disclosure may have one or more associated advantages. For example, a system or method for spectroscopic mapping according to various embodiments of the present disclosure may be used to provide high spectral resolution of 3 nm to 5 nm, simultaneous spectra acquisition from 33 to 120 spots at about 5 to 100 s of Hz, and extended spectral coverage from the UV to near infrared with no moving parts. The system and method may be used for various types of semiconductor process control applications, plasma monitoring applications, and various other applications that may benefit from reflectance and optical emission spectroscopy. The system and method may be used for side-view mapping as well as top-view mapping.

Use of a mask according to various embodiments of the present disclosure provides additional flexibility for specific applications and implementations while using standard-sized optical fibers. Because optical fibers are generally not economically made in any diameter and shape, particularly when they must accommodate UV to NIR wavelengths and be manufactured with UV resistant materials, optical fiber diameters that would normally be limited to a small number of finite values with 70 or 100 μm minimum, can be adjusted with the mask of apertures to precisely set spatial resolution. This provides additional flexibility to define desired size and shapes as needed for particular applications and implementations using a customized mask rather than using cost-prohibitive custom fibers or rather than compromising on application performance parameters.

The above advantages and other advantages and features of the present disclosure will be readily apparent from the following detailed description of the preferred embodiments when taken in connection with the accompanying drawings.

### BRIEF DESCRIPTION OF THE DRAWINGS

FIG. 1 is a block diagram illustrating a representative embodiment of a system or method for spectroscopic mapping according to the present disclosure;

FIG. 2 is a simplified illustration of a spectroscopic mapping system according to various embodiments of the present disclosure;

FIGS. 3A-3-D illustrate representative arrangements of optical fibers at the input end of the optical fiber bundle for use in various embodiments according to the present disclosure;

FIGS. 4A-4C illustrate representative arrangements of apertures for a mask positioned between the object and imaging optics or between the imaging optics and input end of the fiber optic bundle according to embodiments of the present disclosure;

FIGS. 5A-5C illustrate representative aperture shapes and sizes relative to an associated optical fiber according to embodiments of the present disclosure;

FIG. 6 is a block diagram illustrating one embodiment of a spectroscopic mapping system having a plurality of input columns at the entrance of the imaging spectrometer having a plurality of Order Sorting Filters according to the present disclosure;

FIG. 7 illustrates representative imaging optics used to provide a portion of the input light to an imaging camera according to embodiments of the present disclosure;

FIG. 8 illustrates a representative scanning pattern that may be used to provide a desired spatial resolution using relative movement between the object and the first mask or between the first mask and associated optical fibers according to embodiments of the present disclosure; and

FIG. 9 and FIGS. 10A-10C illustrate use of a mask positioned within the imaging optics to reduce background noise.

### DETAILED DESCRIPTION

At least one representative embodiment is described in detail herein; however, it is to be understood that the disclosed embodiment(s) are merely exemplary and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

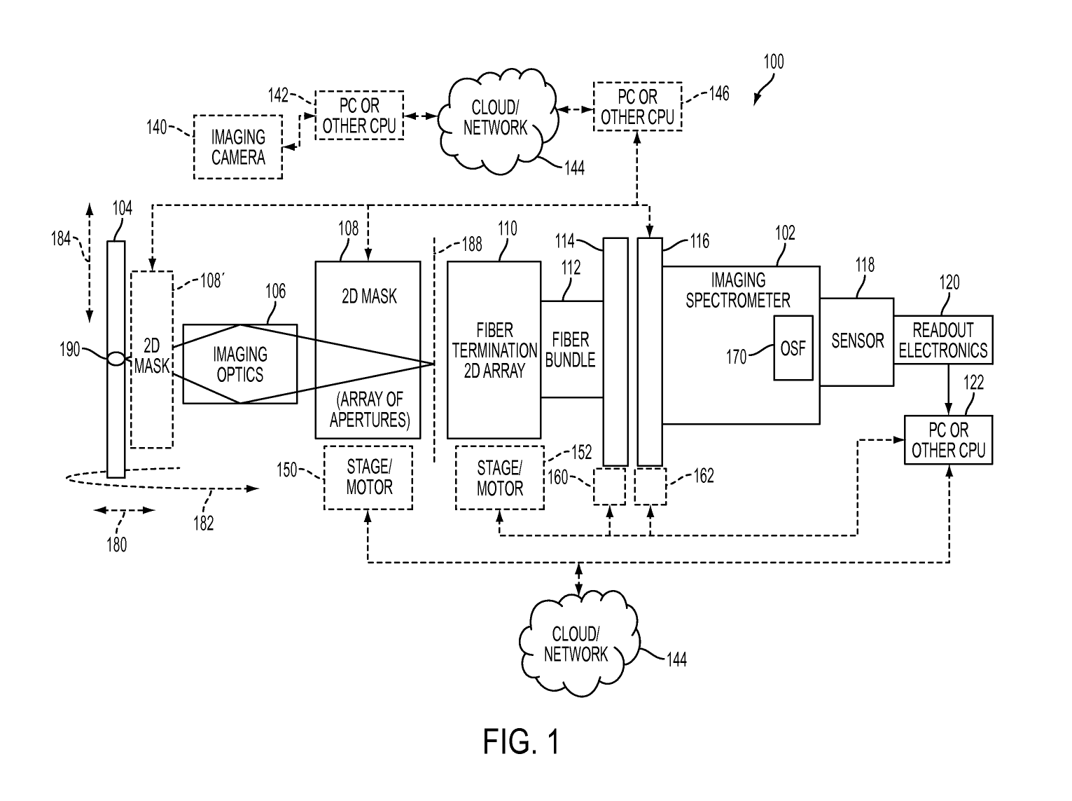

FIG. 1 is a simplified block diagram illustrating a representative embodiment of a system or method for spectroscopic mapping according to the present disclosure. System 100 includes an imaging spectrometer 102 that may be used to generate spectra from an object 104 that may be used in process monitoring, for example. Spectrometer 102 may be implemented by any of a number of spectrometer configurations known to those of ordinary skill in the art including but not limited to the following representative configurations: a concentric Offner configuration having a regular grating or an aberration corrected grating; a concentric Dyson configuration having a regular grating or an aberration corrected grating; an aberration corrected Czerny-Turner configuration, which may include a toroid or an aspheric mirror or a wedged cylindrical lens or Schmidt Corrector; or by a concave imaging grating spectrograph.

Imaging optics 106 generates an image of object 104 at a nominal image plane generally represented at 188. A two-dimensional mask 108 includes a plurality of apertures arranged in an array as illustrated and described in greater detail below. Two-dimensional mask 108 may be positioned between imaging optics 106 and an input end of a fiber optic bundle 112. In some embodiments, two-dimensional mask 108 may be positioned between object 104 and imaging optics 106 as generally represented at 108′. Mask 108′ may be placed above or on top of object 104 in some embodiments. Additional optics (not shown) may be included between the object 104 and imaging optics 106 with mask 108′ positioned in an intermediate image plane so that it combines the mask pattern with the image of the object imaged on the input of the fiber optic bundle 112. A plurality of optical fibers is arranged in an input fiber termination array as represented at 110. Fibers may be arranged in various patterns at the input end of optical fiber bundle 112. Optical fibers within optical fiber bundle 112 extend between two-dimensional fiber termination input array 110 and a fiber termination output array 114. Output array 114 includes a linear array of fibers. In some embodiments, two or more linear arrays or columns of fibers are arranged generally parallel to one another in space relative to one another. Fibers within each linear array or column are spaced out or may be closely packed such that the cladding of each fiber contacts the cladding of at least one other fiber.

A second mask having at least one aperture is generally represented at 116 and is positioned at the input of imaging spectrometer 102. Light entering imaging spectrometer 102 through mask 116 is directed to a grating to generate corresponding spectra that are detected by sensor 118 and converted to associated electrical signals by readout electronics 120. A computer or other processor 122 may be used to analyze the signals generated by readout electronics 122, process the spectra and monitor object 104. Computer or processor 122 may communicate with one or more other computers or processors via the cloud 144.

As generally represented in FIG. 1, system 100 may include various optional components or features generally illustrated by broken or dashed lines. For example, some embodiments may include an imaging camera 140 positioned to receive at least a portion of light from imaging optics 106 to provide a visual image of object 104. As described in greater detail below, imaging optics 106 may include a mechanical device to selectively redirect light from object 104 to imaging camera 140 or image plane 188. Alternatively, imaging optics 106 may include one or more optical elements to direct a small portion of light to imaging camera 140 from object 104. Imaging camera 140 may be connected to a computer or other processor 142 which may in turn be connected to cloud 144 or other computer network. A computer or other processor or controller 146 may be used to control addressable or otherwise controllable mask positions such as two-dimensional mask 108 and spectrometer input mask 116 or fiber bundle output 114, for example, as illustrated and described in greater detail below.

System 100 may also include one or more controllable stages as generally represented by motors, 150 and 152 to move various components in response to associated control signals from a computer, processor, or controller as generally represented at 122, 142, and 146. In one embodiment, a movable stage and motor assembly 150 is provided to translate and/or rotate two-dimensional mask 108 relative to fiber termination input array 110 of optical fiber bundle 112. Similarly, a movable stage and motor assembly 152 may be associated with fiber termination input array 110 as generally represented at 152. Similar devices may be associated with the output and termination array 114 of fiber optic bundle 112 as generally represented by block 160. Likewise, a stage, motor, and/ or other device generally represented at 162 may optionally be associated with second mask 116 to move second mask 116 relative to imaging spectrometer 102, or to adjust aperture of second mask 116 (slit jaws closing and opening) and/or the output end of optical fiber bundle 112 is represented by the output termination array 114.

Depending upon the particular application and implementation, object 104 may also be translated or rotated as generally represented by arrows 180, 182, and 184 relative to imaging optics 106 during operation of the spectroscopic mapping system 100.

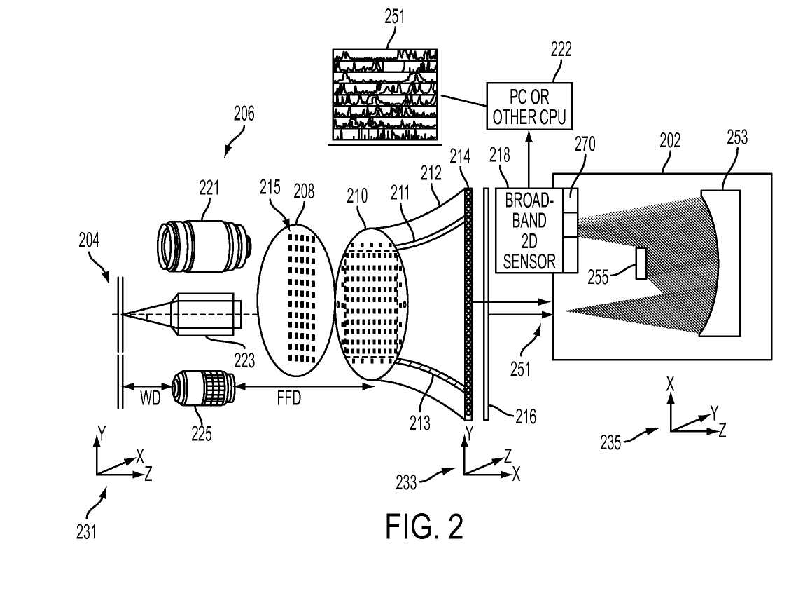

As generally illustrated by the block diagram of FIG. 1, and illustrated and described in greater detail with respect to FIGS. 2-10, various embodiments according to the disclosure may be used to simultaneously or sequentially obtain a plurality of spectra with broad spectral coverage and high spectral resolution, from a high number of spots. A first mask includes an array of apertures that determine or control the spatial resolution, or spot size, of the object or its image onto the fiber bundle array and may be used for mapping the object (whether fixed, translating, or rotating) by using imaging optics to project an image of the object onto the input end or termination array of the fiber optic bundle. The imaging optics may provide magnification, demagnification, or a 1:1 object to image ratio. The first mask positioned between the object and imaging optics, or between the imaging optics and input array of fibers includes a plurality of corresponding pinholes or apertures of selectable size and shape. The fiber bundle converts the two-dimensional input array to at least one vertical line by appropriate positioning of the fibers in the fiber bundle output termination array, which is positioned to direct light into the entrance of an imaging spectrometer (for example concentric or any aberration-corrected design, fitted with entrance slit, fixed, or manually adjustable, or with motorized adjustment, or variable movable mask, capable of resolving a large number of spectra across the vertical plane on its associated two-dimensional sensor, and through an order sorting filter).

A motorized translation and/or rotation stage controlled by a processor or computer may be placed in the focal plane of the imaging lens to move the array of fibers (change the map position) or to move the mask or a set of masks (with various patterns) that selectively expose or hide the fibers to be read by the spectrometer or change the size of the spot from the object being imaged. A second mask may be implemented by a motorized slit and/or mask/pattern placed at the entrance of the spectrometer to select which fiber columns or patterns can be read by the spectrometer, and to adjust the resolution (bandwidth) of the spectrometer. The motorization and multi-column approach drastically increase the number of spots but make the system acquisition to be sequential instead of being instantaneous or simultaneous. The order sorting filter (OSF) may also be motorized to shift in the spectral dimension in accordance with the position of the column of fibers placed at the entrance slit and its offset from nominal position. The OSF may also be an array of two or more individual OSFs, positioned side by side, to accommodate two or more side by side spectra, which are not overlapping due to appropriately selected spacing between the two or more entrance columns of fibers which are being imaged through the spectrometer.

A spectroscopic mapping system or method as illustrated and described with respect to various representative embodiments may be used to instantaneously and continuously capture a spectroscopic full or partial or discrete map from an object (biology sample, semiconductor device, plasma, combustion/flame, etc.) during a process control for uniformity monitoring for example. The number of spots being monitored or mapped may range from a few points (discrete mapping) to as many as the number of fibers that can be stacked in adjacent positions of the 2D array, placed in the focal plane of the objective lens or other imaging optics. Once all fibers are filling the focal plane of the imaging optics and also filling the corresponding number of columns of slits (second mask) which are inputting the light into the imaging spectrometer, hyper spectral imaging performance can be achieved. The two-dimensional sensor of the imaging spectrometer runs continuously at variable rates of acquisition, and all fibers placed in a single column at the input (slit position) of the spectrometer provide live simultaneous spectra readouts. The mapping array can be moved to select different spots, or to add data from other spots. The object may also be moving while the array of fibers is stationary.

FIG. 2 is a simplified illustration of a spectroscopic mapping system according to various embodiments of the present disclosure illustrating representative implementations for the fiber bundle input and output termination arrays and a representative mask. Depending on the particular implementation, embodiments may be constructed without moving parts to provide increased system performance, durability, and reliability in a system that performs broadband spectroscopy (typically 200 nm-2,500 nm) with nearly instantaneous acquisition of spectra with one or multiple imaging spectrometers receiving light from a multi-furcated fiber bundle.

The representative embodiments of a spectroscopic mapping system as illustrated in FIG. 2 include an assembly with imaging spectrometer 202 to map object 204 using imaging optics 206 and first mask 208 to generate an image on input array 210. Fiber optic bundle 212 includes a plurality of fibers generally represented by fibers 211, 213, that extend from input array 210 to output array 214. Fibers 211, 213 may be mapped to specific locations of output array 214, or may be randomly positioned with remapping performed by the computer or other CPU 222. As illustrated in FIG. 2, input array 210 includes fibers spaced apart from one another such that the cladding of adjacent fibers does not come in contact with each other. This is sometimes referred to herein as a “non-adjacent” configuration and is in contrast to the closely packed or “adjacent” configuration of the output array 214 having the fibers aligned or stacked in a column or linear array with each fiber cladding in contact with the cladding of at least one other adjacent fiber.

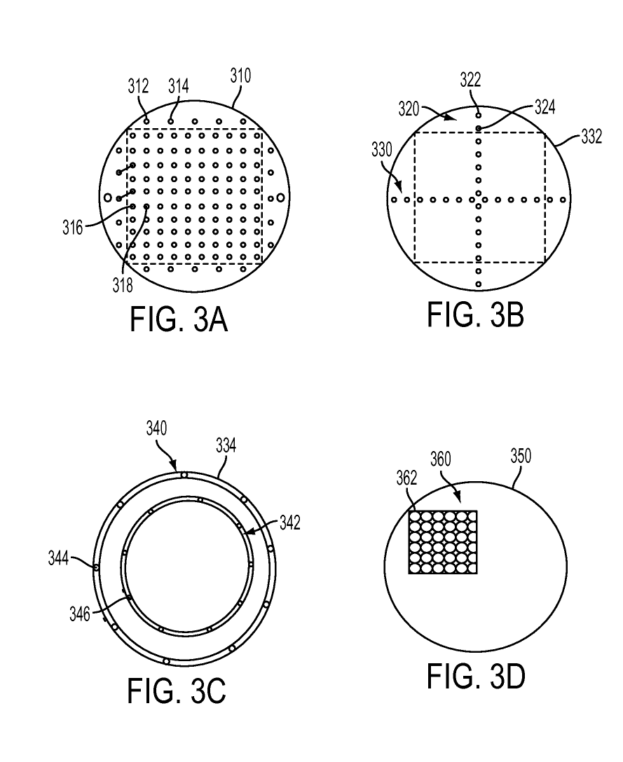

As those of ordinary skill in the art will recognize, the coordinate space or orientation of various components have been selected to best illustrate particular features of the components. For example, imaging optics 206 are illustrated in a first coordinate reference frame 231 while output array 214 is illustrated in a different coordinate reference frame 233. As such, in operation, output array 214 would be positioned to direct light vertically into spectrometer 202 as generally indicated by the coordinate reference frame 235 corresponding to a top view of imaging spectrometer 202. In various embodiments, fibers of input array 210 may be arranged at equidistant and non-adjacent or spaced locations in a pattern that populates a circle matching the size of the focal plane of the chromatically corrected objective lens 221 (for broadband spectroscopy), or it may fill up a square/rectangle pattern as illustrated in FIG. 3D, for example. The linear column of fibers 214 is positioned at the input of the spectrometer 202.

As shown in FIG. 2, WD represents the working distance from the front of the microscope lens 225 or macro lens 221 objective to the object 204, and FFD represents the Flange Focal Distance between the back of the lens and the position of the 2D array of fibers 210. Imaging optics 206 may also be implemented by reflective optics generally represented at 223 rather than lens-based magnifying optics 225 or demagnifying optics 221. In various embodiments, imaging optics 206 may include far-range optical set-ups such as telescopes. A computer controlled stage or similar device (FIG. 1) may be used to move the termination block 210 relative to imaging optics 206. This facilitates translation along the Z focus axis to move the fiber array and optionally the mask 208 relative to imaging optics 206, which may include lens 221, or 225. This adjustment of FFD, combined with a change of WD and lens re-focus allows a spot size adjustment on a large continuous scale to define or control the spatial resolution and complement the mask 208 (from near zero to the fiber diameter).

The total number of fibers may be computed by dividing the height of the 2D sensor 218 by the fiber diameter (cladding diameter or buffer diameter) since the imaging spectrometer works at a 1:1 ratio. The number of fibers may be reduced if inactive or dummy fibers are included between active fibers, to avoid cross-contamination due to residual astigmatism present in limited performance imaging spectrometers. While the fibers are spaced or spread across the 2D array 210, extra fibers may be positioned at the periphery at non equidistant positions. Similarly, one fiber may be placed at the center of the array. The particular spacing and placement of the fibers, as well as the size/diameter of the fibers may vary depending on the particular application and implementation.

The first mask 208 contains a plurality of openings or apertures 215 arranged in an array and positioned in front of corresponding ones of the plurality of fibers with the number of apertures equal to or greater than the number of fibers within bundle 212. The first mask 208 effectively reduces the area of each fiber diameter receiving light from a spot on the object 204, being imaged through the lens 221, 223, or 225, to a size equal to the core diameter of the fiber or a smaller size (round, square, etc.). As such, mask 208 determines or controls the spatial resolution of the system to values that are lower than the limit of a typical existing optical fiber and various masks can be used to activate/de-activate selected fibers and provide a pure spectroscopic image from any spot size at the object plane as generally represented at 190 (FIG. 1). The minimum spot size on the object is set by the magnification of the imaging optics 206 and the size of each aperture 215 in the mask array 208 when the array 208 is in the nominal focal plane (188 in FIG. 1) of the lens or other imaging optics. The distance FFD may be changed from the lens' nominal value to obtain various object spot sizes to be analyzed. The distance WD and focus need to be set differently to achieve this plurality of spot sizes.

The second mask 216, which may be implemented by a single aperture or slit placed on the line of adjacent fibers 214 (or spaced out or separated by dummy fibers) sets the spectral resolution (spectral purity) of the system for all simultaneous spectra being captured, and various patterns can be used to activate/de-activate selected fibers, which may be needed for some imaging spectrometers, particularly those that exhibit an unacceptable level of astigmatism.

Each individual fiber in the line of fibers 214 generates a spectrum on a row of pixels on the 2D sensor 218, through the imaging spectrometer 202, which is virtually free of optical aberrations (particularly has no astigmatism). As previously described, imaging spectrometer 202 may be implemented with a variety of spectrometers of different configurations, which may include a convex grating 255 that is an aberration corrected grating that includes a plurality of curved non-parallel grooves, or where at least some of the curved grooves are unequally spaced from each other.

The sensor 218 may be implemented by an interline device such as a charge coupled device (CCD). In various embodiments sensor 218 may be implemented by a device having independent readings of each pixel (such as a CMOS or sCMOS) or is a full frame or frame transfer CCD/sensor with a fast mechanical shutter, so that all rows of the sensor are illuminated simultaneously, and there is no electronics readout cross-talk contamination between each individual spectrum/fiber. An OSF 270 provides order sorting and allows extension of the spectral range of the spectrometer 202, which would be otherwise limited to a single octave (such as 300-600 nm or 500-1000 nm, for example) since second orders would be contaminating the upper wavelengths. The OSF 270 may be a multi-area rectangle filter having a first area of UV transmitting material, a second area long pass for visible wavelengths, and a third area having a higher long pass for VIS-NIR wavelengths. When provided, OSF 270 may be located inside the spectrometer 202, between the last optical component (concave mirror 253 in this example) and the CCD or other detector 218. Alternatively, it may be a single long pass filter located anywhere in the optical path (typically after the entrance slit), to cover a full octave, without interference from light generated by the object 204, at wavelengths below the cut-on point of the filter.

The object 204 may be a sample that emits light (auto-fluorescence, emission from a plasma, flame from combustion) or it may be excited by a light source (Raman, PL, Fluorescence) or it may be reflecting/transmitting light. An excitation light source can be integrated into the system illustrated in FIG. 1 or 2 to either flood the sample/object 204 (uniform illumination) or image a pattern of light excitation spots by positioning an imaging lens and mask between a light source and the object, to reproduce the same array mask used in the back of the collection lens, or it may be a fixed or moving line or array that focuses the light onto the spots being recorded with the spectroscopic mapper.

In one representative embodiment, sensor 218 is implemented by a 36 mm height CCD. Fibers 211, 213 and other fibers of fiber bundle 212 are implemented by fibers having 100 μm core with 110 μm cladding diameters (buffer removed), which yields 327 fibers or 327 spots, spread in an array of equidistant fibers to provide a corresponding 327 simultaneous UV-VIS spectra generally represented at 251 as generated by PC or other CPU 222 from an object 204 being monitored during a process, for example, at a typical rate of 10-50 Hz. The CCD sensor 218 is extended to detect UV wavelengths using an appropriate coating, back-thinning, etc. to provide between about 2000-3500 pixels. This provides a spectral resolution on a high imaging quality concentric spectrometer as low as 1-2 nm across 200-1000 nm. The OSF 270 will remove any second order contribution. The array mask 208, placed on the fiber array 210, will control spatial resolution from 100 μm down to near zero. The CCD electronics will typically feature a high speed PC interface (USB-3, GigE, Camera Link, etc.) for connection to associated PC or other CPU 222.

In some applications, OSF 270 is implemented by a single-area OSF to extend the spectral range beyond a single octave, or is omitted. Sensor 218 may be implemented by a variety of optical sensors, such as a CCD (interline, full frame, or frame transfer, etc.), an EM CCD, a CMOS or sCMOS, an array of Silicon Photo multipliers, an array of photo multiplier tubes (PMTs), or an array of silicon photodiodes, for example.

FIGS. 3A-3-D illustrate representative arrangements of optical fibers at the input end of the optical fiber bundle for use in various embodiments according to the present disclosure. As illustrated in FIG. 3A, and input termination block 310 may be used to arrange fibers 312, 314, 316, and 318 in various types of patterns. In FIG. 3A, fibers 316 and 318 are spaced from one another and arranged in a generally rectangular or square array with equidistant spacing, while fibers 312, 314 are arranged outside of the rectangular or square array within the generally circular termination block 310. Likewise, while fibers 316, 318 and similarly situated fibers are arranged with generally equidistant spacing, fibers 312, 314 are space relatively farther apart.

FIG. 3B illustrates another arrangement for fibers within an input termination block 332. In this representative embodiment, fibers are arranged in radial lines 320 and 330 form a cross or X pattern separating termination block 332 into quadrants. Individual fibers 322, 324 are equidistantly spaced from one another. Those of ordinary skill in the art will recognize that any of the configurations illustrated may employ fibers spaced closer together with cladding contacting adjacent fibers or further apart. As previously described, inactive or dead fibers may be positioned between active fibers in some embodiments.

FIG. 3C illustrates another arrangement of input fibers within a termination block 334. In this representative embodiment, individual fibers 344, 346 are arranged in corresponding concentric rings 340, 342, respectively. While only two concentric rings are illustrated, various patterns may employ a single concentric ring or multiple concentric rings depending on the particular application and implementation. A concentric arrangement of fibers and apertures, such as illustrated in FIG. 3C, may be desired for applications where object uniformity is monitored because the concentric ring patterns facilitate capture of spectra from the center to the periphery of the object image. The rings may be equidistantly or irregularly spaced relative to one another depending on the particular application.

Another alternative arrangement for termination of the input and of the fiber optic bundle is illustrated in FIG. 3D. A closely packed array 360 of individual fibers 362 covers only a portion of the termination block 350. The area represented by termination block 350 generally corresponds to the image plane of the imaging optics. The regular array 360 of closely packed individual optical fibers 362 may be positioned anywhere within the area of termination block 350. For example, array 360 may be centered within the area represented by termination block 350 rather than at an offset location as illustrated.

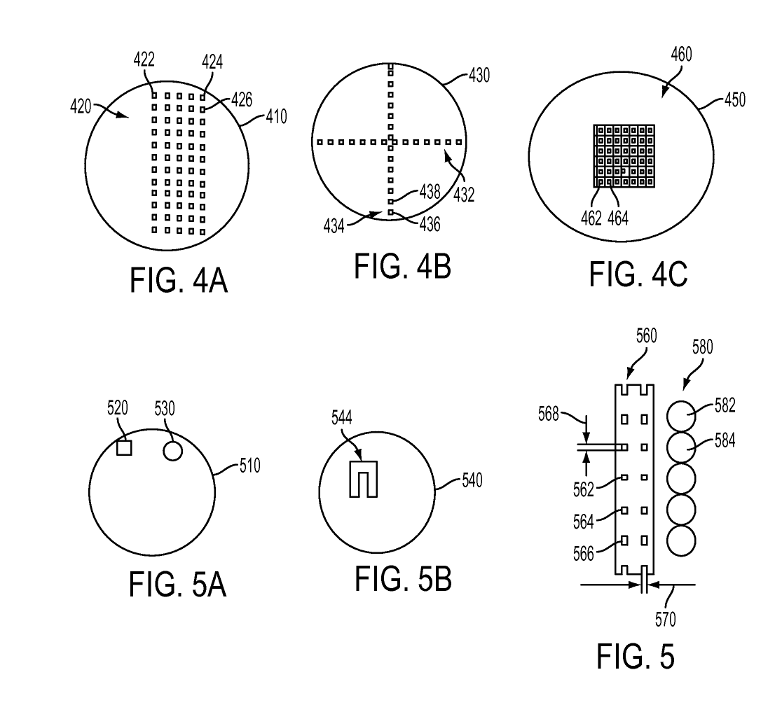

FIGS. 4A-4C illustrate representative arrangements of apertures for a mask positioned between the object and imaging optics or between the imaging optics and input end of the fiber optic bundle according to embodiments of the present disclosure. For many applications, the arrangement or pattern of apertures on the mask will match the number and location of fibers arranged on the input termination block. For example, a mask having apertures arranged as illustrated in FIG. 4B may be used with a fiber termination block as illustrated in FIG. 3B. However, various applications may have a mask with aperture size, shape, and/or position different from the arrangement of a corresponding input end of a fiber optic bundle.

In the representative embodiment illustrated in FIG. 4A, mask 410 includes a plurality of apertures 422, 424, 426 arranged in an array generally indicated by reference 420. In this embodiment, array 420 is a generally rectangular array having equidistantly spaced square apertures. As also illustrated, array 420 is offset relative to the vertical centerline of mask 410 and generally centered or symmetric about a horizontal centerline of mask 410.

FIG. 4B illustrates another mask 430 having linear arrays 432, 434 of apertures 436, 438. Linear arrays 432, 434 are generally perpendicular radial arrays that separate mask 430 into quadrants. The radial or quadrant patterns of fibers and apertures illustrated in FIG. 3B and 4B, respectively, facilitate capturing spectra from the center to the periphery of the object, which may be desirable for applications where object uniformity is monitored, for example.

FIG. 4C illustrates another mask 450 defining a plurality of apertures 462, 464 arranged in a square array 460. While each of the aperture arrays illustrated in FIGS. 4A-4C include apertures having a square shape and arranged in a regular pattern or array, other shapes of apertures may be used for particular applications as illustrated in FIGS. 5A and 5B, for example. Similarly, different spacing may be used as illustrated and described with reference to the fiber spacing of the embodiments illustrated in FIGS. 3A-3C.

FIGS. 5A-5C illustrate representative aperture shapes and sizes relative to an associated optical fiber according to embodiments of the present disclosure. FIG. 5A illustrates a single square aperture 520 having a size/area significantly smaller than the size/area of an associated fiber 510. As described in greater detail below, small apertures such as represented by square aperture 520 and round aperture 530 may be used to facilitate the use of standard fiber sizes for applications that would otherwise require custom shaped or sized fibers. Multiple apertures such as square aperture 520 round aperture 530 may be positioned within a corresponding array of a mask and moved in a designated pattern to scan the area of a corresponding fiber 510.

FIG. 5B illustrates an aperture 544 having an “n” or “u” shape and a size/area significantly smaller than the size/area of a single fiber 540. Aperture 544 may be positioned within an array of similar apertures as illustrated and described with reference to FIGS. 4A-4C.

FIG. 5C illustrates a second mask 560 that may be positioned between the output end or output fiber termination block of the fiber optic bundle and the input to the imaging spectrometer. Mask 560 includes a plurality of generally rectangular apertures 562, 564, and 566 having equal widths 570 and heights 568 that vary in relationship to a distance from the middle aperture. In the representative embodiment illustrated, the aperture height increases for apertures farther away from middle aperture 562 to provide an intensity equalizing or balancing function for light delivered by an associated optical fiber column 580 having individual fibers 582, 584 arranged in a stacked column at the output end of the fiber optic bundle as illustrated and described with reference to FIG. 2.

Many imaging spectrometers are known to have non-uniform transmission when comparing the signal from a fiber entering the spectrometer at the nominal center of the entrance slit, relative to the signal from a fiber getting into the spectrometer with a given vertical offset (inside the single column of fibers, located up or down from the central or middle fiber) or horizontal offset (inside an additional or shifted column of fibers located on the left and right of the central nominal column). This may result in different responses/throughputs of the system for its various channels and may not be acceptable in some applications. Attempting to correct it with slit width adjustments is not an acceptable option since it also changes the bandpass/spectral resolution, between each fiber channel. As described above and illustrated in FIG. 5C, the mask implemented by single or multiple slits positioned at the spectrometer input may include unequal aperture sizes/areas that increase as a function of distance from the center/middle aperture. The aperture areas or dimensions may be calculated after recording an initial throughput of the multiple fiber channels with equal slit apertures or no apertures. The same growing size of the apertures (from nominal to outer) can be applied on the 2D array of apertures on the other end of the fiber bundle, located at the input of the 2D array of fibers, if having unequal spatial resolution (unequal spot sizes at object position) is acceptable.

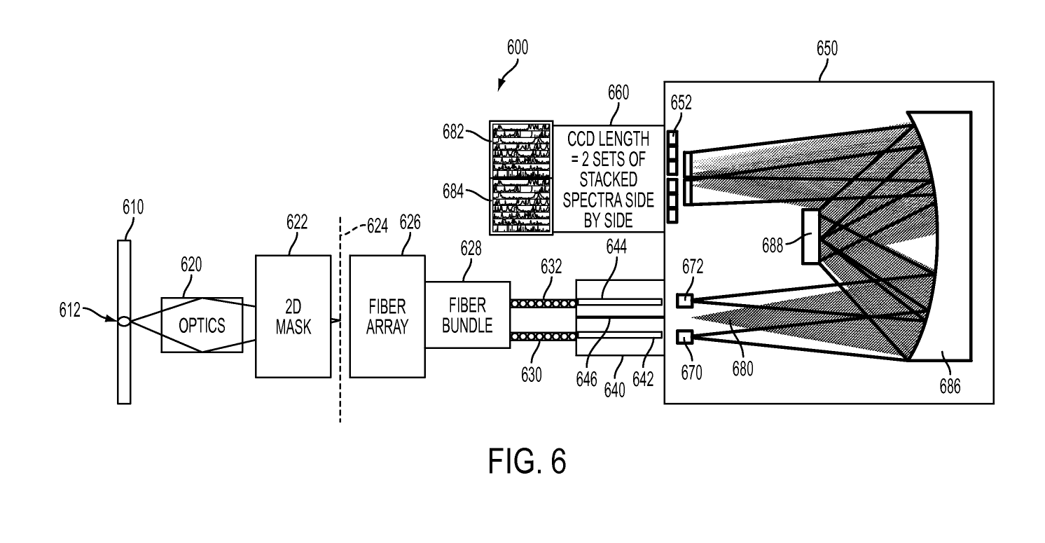

FIG. 6 is a block diagram illustrating one embodiment of a spectroscopic mapping system having a plurality of input columns at the entrance of the imaging spectrometer according to the present disclosure. This configuration 600 with 2 (or more) columns of fibers 630, 632 allows simultaneous acquisition of two columns without overlaps, compared with prior art strategies that require moving parts to select one or the other column and do not have an OSF 652 with repeated pattern positioned in front of the 2D sensor 660 (or 2 longpass filters after the input slits). System 600 is similar to previously described configurations with an area of interest 612 within an object plane 610 imaged by optics 620 through a two-dimensional mask 622 having a plurality of apertures arranged in an array to an image plane 624. An input fiber array 626 includes fibers arranged in a pattern or array as described with respect to other embodiments. Fiber bundle 628 has an output end with two or more linear or stacked columns as represented at 630, 632 of adjacent or closely stacked fibers that may have cladding in contact with one another.

A second mask 640 implemented by slits 642, 644 spaced a distance based on the size (length) of sensor 660. Second mask 640 is positioned at the entrance of spectrometer 650 relative to a nominal input position 646, which would result in light following the nominal optical path designated at 680. In these embodiments, first and second columns of fibers 630 pass light through corresponding slits 642, 644, respectively of second mask 640. Slits 642, 644 are offset from nominal 646 by a value to prevent overlap of spectra 682, 684 generated on sensor 660. Light passing through slit 644 follows an optical path 672 to concave mirror 686 and grating 688 before being directed back to concave mirror 686 and to detector 660 after passing through a corresponding region of one of the two OSF 652. Light passing through slit 642 follows an optical path 670. Stacked spectra 682, 684 represent as many spectra vertically as there are fibers in a column. Each column 630, 632 may include the same number of fibers, or may have a different number relative to the other column.

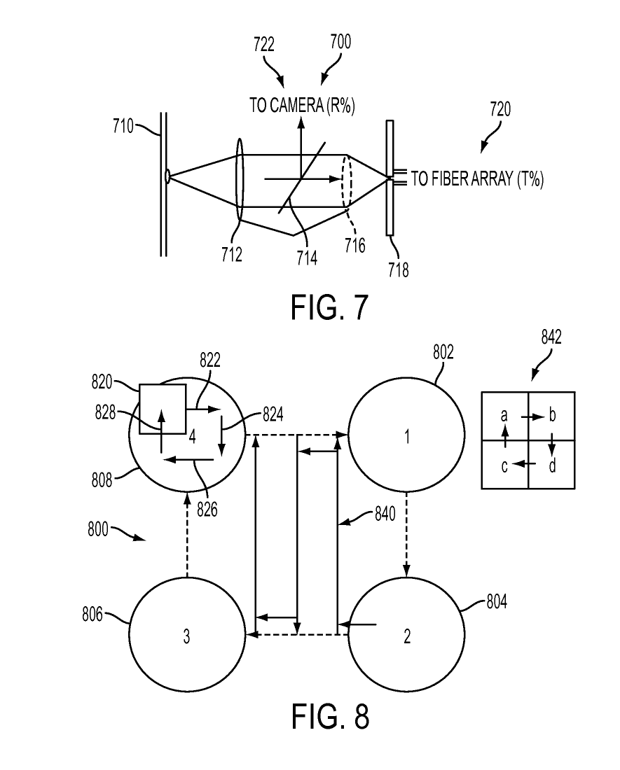

FIG. 7 illustrates representative imaging optics 700 that may be used to provide a portion of the input light to an imaging camera according to embodiments of the present disclosure. As previously described, an imaging camera may be provided to provide a visual image of the object. Light may be provided to the imaging camera using an optical arrangement as shown in FIG. 7, for example. Object plane 710 is imaged by lens 712 and lens 714 to image plane 718 and fiber array 720 of the input end of the fiber optic bundle. An optical element 714 directs at least a portion of light from object 710 passing through lens 712 to an associated camera 722. Optical element 714 may be a mirror with an associate mechanism to swing away or translate to a different position to allow light to pass through the system when camera 722 is not in use, or is being blanked to acquire a spectral image. Alternatively, optical element 714 may be implemented by a reflecting/partially transmitting mirror that reflects a predetermined % of the image onto a secondary camera for imaging purposes only. Such semi-transparent mirror may be positioned between the object and the imaging optics, or between the imaging optics and the 2D array of fibers. The semi-transparent optics allow simultaneous acquisition of the image of the object on the Imaging camera and of the spectroscopic map, e.g. the multi-spectra (one spectrum per spot) on the 2D sensor, in the case of a semi-transparent mirror, with for example ranges from 50-50% R/T ratio, to any low % value for the imaging camera side, and high % value for the spectroscopic mapping side or branch Sequential acquisition is used where a swing-away or translate-away mirror is provided

The semi-transparent optics with transmission+reflection close to 100% may also be integrated between optics, in a parallel beam of light for better performance of such dichroic filter.

FIG. 8 illustrates a representative scanning pattern that may be used to provide a desired spatial resolution using relative movement between the first mask and associated optical fibers according to embodiments of the present disclosure. As described with reference to the representative embodiments of FIGS. 1 and 2, the spectroscopic mapping system may include a translation/scanning stage or similar device located between the imaging optics and the input end of the fiber bundle fiber termination attachment to provide X-Y translation of the 2D array of fibers and optionally of the mask, with respect to the imaging optics, and optically with respect to the Z focus.

In some embodiments, the fiber array and the mask array can move independently and sequentially or simultaneously relative to one another. First moving the array of spaced, non-adjacent fibers gives a new updated map (covering the whole object) after each step of the movement, and minimizes the total movement so that the fiber bundle does not fatigue and break due to repeated movements over a large area.

The small apertures allow the user to scan the subsets of each single fiber area (active diameter) to take the spatial resolution beyond the fiber diameter limitation of previous scanning and mapping systems.

This X-Y scanning preferably follows a “P” pattern 800 as generally illustrated in FIG. 8 moving one direction and then the opposite direction as represented by line 840 so that each single fiber 802, 804, 806, and 808 returns to its original position. In these embodiments, a computer or processor controlled motor/stage may be programmed to minimize the travel distance and time in small steps and over a narrow range (one fiber to next) to prevent damaging the fibers within the bundle while allowing a full scan of the image of the object within the image plane therefore yielding HyperSpectral Imaging.

The 2D array mask 842 positioned in front of the fiber array may follow the same pattern or a similar pattern as generally represented by pattern a, b, c, d of apertures/mask 842. When the apertures are smaller than the fiber diameter, such as aperture 820 relative to diameter of fibers 802, 804, 806, 808, aperture 820 arranged within an associated mask (not shown) may be moved with smaller steps generally represented by lines 822, 824, 826 and 828 in order to obtain improved spatial resolution. A photographic bellows may be connected between the moving components to prevent light leaks while allowing relative movement therebetween.

In a representative scanning sequence, fiber 802 will scan down, up and down, and translate (left/right) passing through positions 2, 3, 4 associated with the original positions of fibers 804, 806, and 808, respectively and come back to its original position 1 after having scanned all possible positions between the square made by 1-2-3-4. The step size for each movement may correspond to the fiber diameter. Steps larger than the fiber diameter have the effect of sampling the area while steps small than the fiber have of higher spatial resolution scanning At all points in time, each acquisition gives an updated map by virtue of the fibers being spaced or spread out in a non-adjacent configuration.

For each fiber position, during a fiber scan, the mask 842 and associated apertures 820, which, in the example below is half the fiber diameter, will scan positions a-b-c-d, before each fiber moves to its next position from 1-2-3-4. The aperture represents the spatial resolution capability or the smallest spot of the object it can monitor. Smaller apertures will pass through many more positions than the representative a-b-c-d positions illustrated to cover the area of a single fiber. As previously described, relative movement may include relative rotation rather than X-Y translation. As also previously described and illustrated, the apertures may be of any shape to monitor particular features of the object.

Movement patterns other than those shown in FIG. 8 may be provided between the imaging optics and the fiber attachment depending on the particular capabilities of the motor/stage or other device. For example, a rotatable/spinning stage (optionally combined with a translation to obtain alternative patterns of movement) located between the lens or other imaging optics and the fiber attachment may allow rotation of the 2D array of fibers up to a full turn or two and back to prevent damaging fibers within the fiber bundle. The mask may also rotate and/or translate via an associated stage/motor. This spinning of the various patterns of the 2D array may be used with the concentric ring and radial/quadrant pattern arrangements illustrated with respect to FIGS. 3 and 4. Depending on the particular characteristics of the fiber bundle, the bundle may be returned to a home or reference position after a ¼ ½ or a full turn for example. The 2D Array Mask in front of the fiber array may follow the same movement, particularly if fibers are made closely packed in contact with one another (also referred to as an adjacent fiber configuration) in order to improve spatial resolution beyond each individual fiber diameter using a mask with apertures having areas smaller than the associated fiber area.

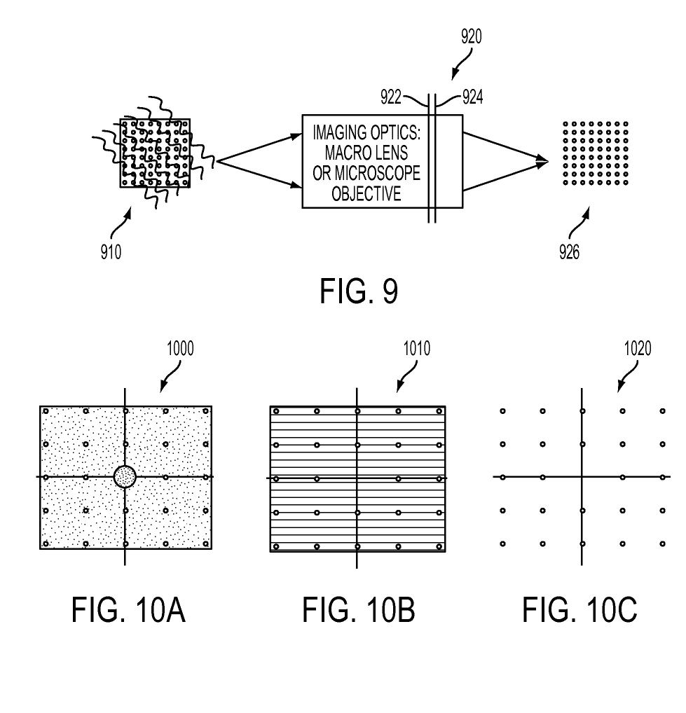

FIG. 9 and FIGS. 10A-10C illustrate use of a mask positioned within the imaging optics to reduce background noise. Although the system allows for the capture of broadband spectra, some specific applications only require the acquisition of a quasi-monochromatic wavelength (examples: monitoring of plasma optical emission spectroscopy at a given spectral band, light absorption of a given sample at a specific wavelength, capture of a specific band of emission fluorescence from a single-wavelength excitation, etc). Under such conditions and under the provision that the captured image is composed of equally-spaced spots on a rectangular or circular grid (i.e. the imaged grid is of a known and well-defined spatial frequency), the principles applicable under the coherent paraxial optics rules can be utilized to filter and improve the quality of the image which is focused on the array mask or fiber array placed at the exit focal plane of the imaging optics.

In coherent optics, the spatial frequency content of an image is physically accessible, and therefore modifiable and editable, in the Fourier plane of the imaging optics. Placement of physical filters or masks in this Fourier plane allows for the enhancement and transmission of only relevant spatial frequency corresponding exactly to the grid pattern, while attenuating or removing other undesirable spatial frequencies attributable to background noise, background pattern, interference pattern due to multi-reflections of the single excitation wavelength on the sample under measurement, other patterns present in the object but not desirable to acquire, etc.

FIG. 9 represents an object having a relevant pattern of spots for spectral monitoring in an optically noisy environment at 910 with background interference and background contaminating light, for example. A physical mask 924 is positioned at or near the Fourier plane 922 within the imaging optics 920, which may include a macro lens or microscope objective, for example. FIG. 10A represents a Fourier image 1000 illustrating spatial frequencies within the observed scene 910. FIG. 10B is a representative physical mask 1010 that can be positioned at or near the Fourier plane 922 (as represented by mask 924). FIG. 10C represents the resulting Fourier image in the Fourier plane after applying the physical mask of FIG. 10B. The resulting image plane is represented at 926 with only spatially relevant pattern of spots remaining and the spatial information associated with the background interference and contaminating light removed.

As previously described with reference to FIG. 1, one or more of the masks may be implemented by addressable or programmable arrays of elements or pixels that may be selectively controlled to function as apertures within a corresponding mask. Multiple adjacent pixels or similar elements may be combined to alter the effective shape of each aperture within a corresponding array. Similarly, rather than physically moving a mask to scan across the input fibers, a programmable mask can be programmed to simulate or effectively scan by controlling a sequence of apertures to sequentially open and close.

Masks having selectively controllable or programmable apertures may include the first mask implemented by a 2D array mask positioned between the object and the input end of the fiber bundle, as well as the second mask or slit array positioned between an output end of the fiber bundle and the entrance of the imaging spectrograph. Similarly, the third mask implemented by the Fourier mask described with reference to FIGS. 9 and 10A-10D placed in the Fourier plane of the imaging lens or microscope objective may include a selectively controllable aperture array.

Selectively controllable aperture arrays may be implemented by transparent or semi-transparent LCD panels, OLEDs, or active-matrix liquid crystal displays or any other devices of the same working principle whose pixels are digitally addressable to turn them on or off to transmit or block incident light. The matrix of addressed pixels then simulates a physical array mask or slit array that is changeable, without the need to move any parts, by simply re-addressing the pixels inside the matrix into another pattern or grid.

As previously described, embodiments may include one or more controllable stage/motor devices to move the object, array mask, fiber input termination block, etc. relative to one another to scan the image of the object. Other embodiments may scan the object while the image (corresponding to the array mask or slit array) is fixed using MEMS devices with arrays of micro-scanning mirrors to scan the object scene (the object scene being either the object itself, or the imaged spots from the macro lens or other imaging optics, or the columns of fibers from the output end of the fiber bundle). Such scanning devices can provide either discrete scanning (on/off, such as as a commercially available DLP-based chip), or continuous scanning from one extreme position to another and can be based, for example, on an addressable array of micro-mirrors built on a MEMS architecture.

The scanning device can be placed between the object and the imaging optics, or between the imaging optics and the array mask, or between the multi-columns of fibers and the slit array at the spectrograph entrance.

The processes, methods, algorithms, or logic used to process or analyze the spectra or control movement of one or more elements, or control selective addressing of controllable apertures within a mask can be deliverable to or implemented by a processing device, controller, or computer, which can include any existing programmable electronic control unit or dedicated electronic control unit or circuitry. Similarly, the processes, methods, or algorithms can be stored as data and instructions executable by a controller or computer in many forms including, but not limited to, information permanently stored on non-writable storage media such as ROM devices and information alterably stored on writeable storage media such as flash memory, magnetic tapes or disks, optical tape or disks, RAM devices, and other magnetic, optical, and combination media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software, and firmware components.

While exemplary embodiments are described above, it is not intended that these embodiments describe all possible forms of the invention. Rather, the words used in the specification are words of description rather than limitation, and it is understood that various changes may be made without departing from the spirit and scope of the disclosure and claimed subject matter. Additionally, the features of various implementing embodiments may be combined to form further embodiments not explicitly described or illustrated, but within the scope of the disclosure and claimed subject matter and recognizable to one of ordinary skill in the art.

While various embodiments may have been described as providing advantages or being preferred over other embodiments or prior art implementations with respect to one or more desired characteristics, as one of ordinary skill in the art is aware, one or more features or characteristics may be compromised to achieve desired overall system attributes, which depend on the specific application and implementation. These attributes include, but are not limited to: cost, strength, durability, life cycle cost, marketability, appearance, packaging, size, serviceability, weight, manufacturability, ease of assembly, etc. Embodiments described as less desirable than other embodiments or prior art implementations with respect to one or more characteristics are not necessarily outside the scope of the disclosure and may be desirable for particular applications.

1. A system for spectroscopic mapping of an object, the system comprising:
a fiber optic bundle having a plurality of optical fibers arranged in a first array at an input end and arranged in at least one linear array at an output end;
a first mask defining a plurality of apertures, the plurality of apertures equal to or greater in number than the plurality of optical fibers, the first mask disposed between an object to be imaged and the input end of the fiber optic bundle;
an imaging spectrometer positioned to receive light from the output end of the fiber optic bundle and to generate spectra of the object; and
a sensor associated with the imaging spectrometer that converts the spectra to electrical output signals.

2. The system of claim 1 wherein each of the plurality of optical fibers includes a core surrounded by a cladding and wherein the plurality of optical fibers are spaced one from another at the input end of the fiber optic bundle such that the cladding of each fiber does not contact the cladding of any other fiber.

3. The system of claim 2 wherein the plurality of fibers is arranged at the output end such that the cladding of each fiber contacts the cladding of at least one adjacent fiber.

4. The system of claim 1 further comprising:
imaging optics positioned between the object and the input end of the fiber optic bundle such that an image of at least a portion of the object is projected onto the input end of the fiber optic bundle.

5. The system of claim 4 wherein the imaging optics directs at least a portion of light from the object away from the input end of the fiber optic bundle for imaging by an imaging camera.

6. The system of claim 4 wherein the first mask is positioned between the imaging optics and the object, or on the object.

7. The system of claim 4 wherein the first mask is positioned between the imaging optics and the input end of the fiber optic bundle, or on the input end of the fiber optic bundle.

8. The system of claim 1 wherein the first mask comprises a plurality of elements arranged in an array, each element controllable by a processor to selectively transmit light or block light in response to a corresponding signal.

9. The system of claim 1 further comprising:
a movable stage coupled to at least one of the first mask and the input end of the fiber optic bundle; and
a processor programmed to operate the movable stage to move the first mask relative to the input end of the fiber optic bundle.

10. The system of claim 1, the plurality of optical fibers being arranged equidistantly relative to one another within the first array at the input end of the fiber optic bundle to control spatial resolution of the spectra.

11. The system of claim 1 wherein the imaging spectrometer comprises:
a grating positioned to receive light from the output end of the fiber optic bundle; and
a multi-area order sorting filter positioned between the grating and the sensor.

12. The system of claim 11 further comprising a second mask positioned between the output of the fiber optic bundle and an input of the imaging spectrometer.

13. The system of claim 12, the second mask including a plurality of apertures having equal widths and heights that vary as a function of distance from a middle aperture.

14. The system of claim 12, the second mask including a plurality of slits spaced one from another a distance to prevent overlap of spectra projected onto the sensor.

15. The system of claim 1 wherein the first array at the input end of the fiber optic bundle comprises first and second radial lines.

16. The system of claim 1 wherein the plurality of apertures of the first mask is arranged in concentric rings.

17. The system of claim 1 further comprising:
a motor associated with the input end of the fiber optic bundle; and
a processor programmed to operate the motor to align an image plane of the imaging spectrometer with the input end of the fiber optic bundle.

18. The system of claim 1 wherein the plurality of optical fibers is arranged in a single column at the output end.

19. The system of claim 1 further comprising a third mask having an array of apertures, the third mask positioned at a Fourier plane of the imaging spectrometer.

20. The system of claim 1 further comprising:
a mirror-based micro-scanning device positioned between the object and the imaging spectrometer in communication with a processor, the processor controlling the device to scan light from the object from a first position to a second position across an entrance of the spectrometer.

21. The system of claim 1 further comprising a movable stage adapted for holding the object and controllable by at least one processor.

22. (canceled)

23. The system of claim 1 wherein the imaging spectrometer comprises an aberration corrected grating.

24. The system of claim 1 wherein the sensor comprises one of an interline CCD, a full frame CCD, a frame transfer CCD, an EMC CD, a CMOS, a sCMOS, an array of silicon photo multipliers, an array of photo multiplier tubes (PMTs) and an array of silicon photodiodes.

25. The system of claim 1 wherein the imaging spectrometer comprises an order sorting filter having a plurality of areas each associate with one of plurality of spectra generated by a corresponding one of a plurality of columns of optical fibers positioned at an output end of the fiber optic bundle, each of the plurality of columns spaced one from another to prevent overlap of associated spectra projected onto the sensor.

26. The system of claim 12 further comprising:
a movable stage coupled to at least one of the second mask and an output end of the fiber optic bundle; and
a processor programmed to operate the movable stage to move the second mask relative to the output end of the fiber optic bundle or to move the output end of the fiber optic bundle relative to the imaging spectrometer.

27. A method for spectroscopically mapping an object using an imaging spectrometer, comprising:
imaging the object on an input end of a fiber optic bundle having a plurality of optical fibers arranged in a two-dimensional array at an input end and at least one linear array at an output end, the output end directing light to an input of the imaging spectrometer; and
positioning a first mask having a plurality of apertures between the object and the input end of the fiber optic bundle, the plurality of apertures being greater than or equal in number to the plurality of optical fibers.

28. The method of claim 27 further comprising moving at least one of the first mask and the input end of the fiber optic bundle relative to one another.

29. The method of claim 27 wherein:
imaging the object comprises positioning imaging optics between the object and the input end of the fiber optic bundle to align an image plane of the imaging optics with the input end of the fiber optic bundle; and positioning a first mask comprises positioning the first mask between the object and the imaging optics.

30. The method of claim 29 further comprising positioning a second mask between the output end of the fiber optic bundle and the input of the imaging spectrometer.

31. The method of claim 30 further comprising positioning a third mask at a Fourier plane of the imaging spectrometer.
